(19) United States
(12) Patent Application Publication
(10) Pub. No.: US 2016/0285321 A1
(43) Pub. Date: Sep. 29, 2016

(54) RECTIFYING CIRCUIT FOR HIGH-FREQUENCY POWER SUPPLY

(71) Applicant: MITSUBISHI ELECTRIC ENGINEERING COMPANY, LIMITED, Chiyoda-ku, Tokyo (JP)

(72) Inventors: Yoshiyuki AKUZAWA, Chiyoda-ku (JP); Kiyohide SAKAI, Chiyoda-ku (JP); Toshihiro EZOE, Chiyoda-ku (JP); Yuki ITO, Chiyoda-ku (JP)

(73) Assignee: MITSUBISHI ELECTRIC ENGINEERING COMPANY, LIMITED, Chiyoda-ku, Tokyo (JP)

(21) Appl. No.: 15/034,436

(22) PCT Filed: Dec. 26, 2013
(86) PCT No.: PCT/JP2013/084828

§ 371 Date: May 4, 2016

(51) Int. Cl. H02J 50/20

(52) U.S. Cl. CPC H02J 50/20

(57) ABSTRACT

Disclosed is a rectifying circuit for high-frequency power supply that rectifies an alternating voltage at a high frequency exceeding 2 MHz, the rectifying circuit for high-frequency power supply including a voltage doubler rectifier circuit that rectifies the alternating voltage inputted from a reception antenna for power transmission 10, a partial resonance circuit that causes the voltage doubler rectifier circuit to perform partial resonant switching in a switching operation at the time of rectification, a matching functional circuit that has a function of matching a resonance condition to that of the reception antenna for power transmission 10, and a function of matching the resonance condition to that of the partial resonance circuit, and a smoothing functional circuit that smooths the voltage rectified by the voltage doubler rectifier circuit into a direct voltage.

### FIELD OF THE INVENTION

The present invention relates to a rectifying circuit for high-frequency power supply that rectifies an alternating current power supply at a high frequency.

### BACKGROUND OF THE INVENTION

A voltage doubler rectifier circuit according to a conventional technology is shown in FIG. 13. In the voltage doubler rectifier circuit, an inputted alternating voltage Vin at a frequency of around 100 kHz is rectified and is converted into a direct voltage, and the direct voltage is outputted (for example, refer to patent reference 1). Though the voltage doubler rectifier circuit corresponds to a technology assuming a frequency band of around 100 kHz, it is adapted to be applicable to a frequency band equal to or less than 2 MHz.

### RELATED ART DOCUMENT

### Patent Reference

Patent reference 1: Japanese Unexamined Patent Application Publication No. 2008-104295

### SUMMARY OF THE INVENTION

### Problems to be Solved by the Invention

However, in the conventional configuration, a problem is that when the conventional one is applied to the rectification at a high frequency exceeding 2 MHz, the power conversion efficiency is poor. Particularly, in a case where a circuit, such as a resonant type reception antenna, which has high frequency characteristics in its output impedance is connected to an input side of the voltage doubler rectifier circuit, an influence is exerted upon the operation of the voltage doubler rectifier circuit itself, and an efficient power conversion operation which is an essential object cannot be maintained. Then, the power loss in the circuit which occurs at the time of the rectifying operation results in heat energy and hence a temperature of the circuit board rises. This results in an increase in the operating environment temperature of the circuit board and a reduction in the life of the used parts. Therefore, a measure, such as a measure of providing an exhaust heat device, is needed, and the conventional configuration also causes an increase in cost, upsizing, and an increase in mass.

The present invention is made in order to solve the above-mentioned problems, and it is therefore an object of the present invention to provide a rectifying circuit for high-frequency power supply that can provide a high power conversion efficiency characteristic in rectification of an alternating voltage at a high frequency exceeding 2 MHz.

### Means for Solving the Problem

According to the present invention, there is provided a rectifying circuit for high-frequency power supply that rectifies an alternating voltage at a high frequency exceeding 2 MHz, the rectifying circuit for high-frequency power supply including a voltage doubler rectifier circuit that rectifies the alternating voltage inputted from a reception antenna for power transmission, a partial resonance circuit that causes the voltage doubler rectifier circuit to perform partial resonant switching in a switching operation at the time of rectification, a matching functional circuit that has a function of matching a resonance condition to that of the reception antenna for power transmission, and a function of matching the resonance condition to that of the partial resonance circuit, and a smoothing functional circuit that smooths the voltage rectified by the voltage doubler rectifier circuit into a direct voltage.

### Advantages of the Invention

Because the rectifying circuit for high-frequency power supply according to the present invention is configured as above, a high power conversion efficiency characteristic can be provided in the rectification of the alternating voltage at a high frequency exceeding 2 MHz.

### BRIEF DESCRIPTION OF THE FIGURES

FIG. 1 is a diagram showing the configuration of a rectifying circuit for high-frequency power supply according to Embodiment 1 of the present invention;

FIG. 2 is a diagram showing another example of the configuration of the rectifying circuit for high-frequency power supply according to Embodiment 1 of the present invention;

FIG. 3 is a diagram showing another example of the configuration of the rectifying circuit for high-frequency power supply according to Embodiment 1 of the present invention;

FIG. 4 is a diagram showing another example of the configuration of the rectifying circuit for high-frequency power supply according to Embodiment 1 of the present invention;

FIG. 5 is a diagram showing another example of the configuration of the rectifying circuit for high-frequency power supply according to Embodiment 1 of the present invention;

FIG. 6 is a diagram showing another example of the configuration of the rectifying circuit for high-frequency power supply according to Embodiment 1 of the present invention;

FIG. 7 is a diagram showing another example of the configuration of the rectifying circuit for high-frequency power supply according to Embodiment 1 of the present invention;

FIG. 8 is a diagram showing another example of the configuration of the rectifying circuit for high-frequency power supply according to Embodiment 1 of the present invention;

FIG. 9 is a diagram showing another example of the configuration of the rectifying circuit for high-frequency power supply according to Embodiment 1 of the present invention;

FIG. 10 is a diagram showing another example of the configuration of the rectifying circuit for high-frequency power supply according to Embodiment 1 of the present invention (in a case in which a variable resonance condition LC circuit is disposed);

FIG. 11 is a diagram showing the configuration of the configuration of the rectifying circuit for high-frequency power supply according to Embodiment 2 of the present invention (in a case in which FETs are used instead of diodes);

FIG. 12 is a diagram showing another example of the configuration of the rectifying circuit for high-frequency power supply according to Embodiment 2 of the present invention (in a case in which diodes and FETs are used); and

FIG. 13 is a diagram showing the configuration of a conventional rectifying circuit for high-frequency power supply.

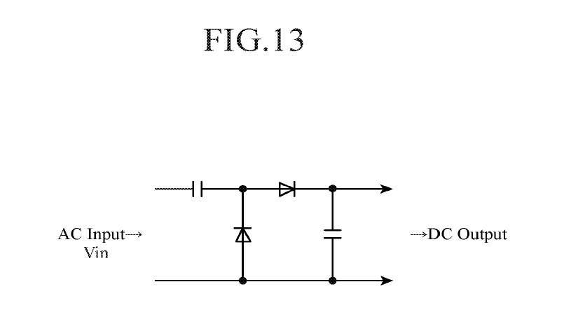

### EMBODIMENTS OF THE INVENTION

Hereafter, the preferred embodiments of the present invention will be explained in detail with reference to the drawings.

### Embodiment 1

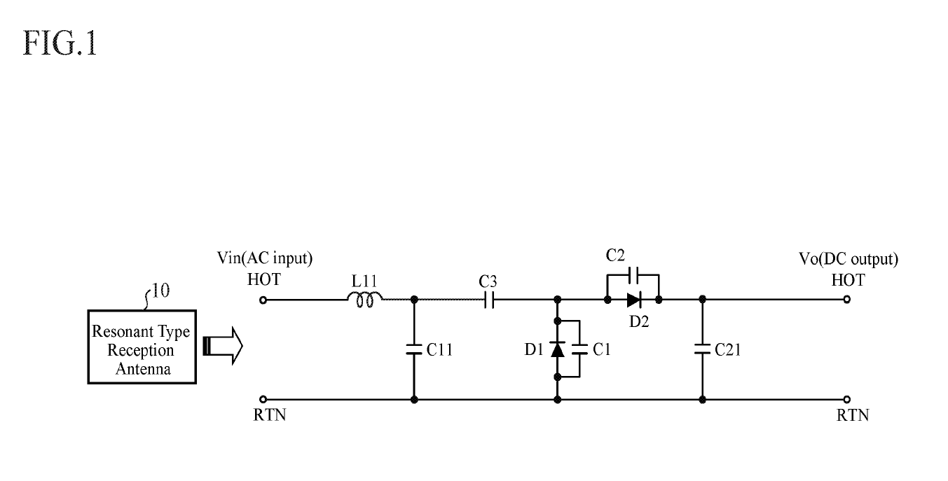

FIG. 1 is a diagram showing the configuration of a rectifying circuit for high-frequency power supply according to Embodiment 1 of the present invention.

The rectifying circuit for high-frequency power supply rectifies an alternating voltage Vin at a high frequency exceeding 2 MHz. This rectifying circuit for high-frequency power supply is configured with diodes D1 and D2, capacitors C1, C2, C3 and C11, an inductor L11 and a capacitor C21, as shown in FIG. 1.

Additionally, a resonant type reception antenna (a reception antenna for power transmission) 10 is a resonant type antenna for power transmission having LC resonance characteristics (which is not limited only to a noncontact type one). The resonant type reception antenna 10 can be of any of magnetic-field resonance type, electric-field resonance type, and electromagnetic induction type.

The diodes D1 and D2 and the capacitor C3 construct a voltage doubler rectifier circuit for converting the alternating voltage Vin at a high frequency exceeding 2 MHz, which is inputted from the resonant type reception antenna 10, into a direct voltage. The diodes D1 and D2 are rectifying elements that convert the inputted direct voltage Vin into the direct voltage. In addition, when converting the inputted alternating voltage Vin into the direct voltage, the capacitor C3 performs an operation that amplifies the voltage twice, together with the diodes D1 and D2. As the diodes D1 and D2, not only diodes for high frequency (RF; Radio Frequency) but also elements, such as diodes of, for example, Si type, SiC type or GaN type, or Schottky barrier diodes, can be used. Further, as the capacitor C3, a ceramic capacitor or a film capacitor or the like can be used.

The capacitors C1, C2, C3 and C11 and the inductor L11 construct a partial resonance circuit for a rectifying operation in the diodes D1 and D2 by using a compound function. The partial resonance circuit causes the diodes D1 and D2 to perform partial resonant switching in a switching operation at the time of rectification. The capacitors C1 and C2 are constants that consist of either the parasitic capacitances of the diodes D1 and D2 or combined capacitances of the parasitic capacitances and the capacitance of a discrete element.

Further, as the capacitor C11, the ceramic capacitor, a tantalum capacitor, the film capacitor or the like can be used. Further, as the inductor L11, an air-core coil, a magnetic material coil or the like can be used.

The capacitor C21 is an element that constructs a smoothing functional circuit for smoothing a ripple voltage after being rectified by the diodes D1 and D2 into a direct voltage. As the capacitor C21, an element, such as the ceramic capacitor, the tantalum capacitor or the film capacitor, can be used.

The inductor L11 and the capacitor C12 are elements which construct a matching functional circuit having a function of performing impedance matching with the resonant type reception antenna 10 on an input side (matching the resonance condition to that of the resonant type reception antenna 10), and a function of performing impedance matching with the partial resonance circuit configured with the capacitors C1, C2, C3 and C11 and the inductor L11 (matching the resonance condition to that of the partial resonance circuit) . As the inductor L11, the air-core coil, the magnetic material coil or the like can be used. By virtue of the inductor L11 and the capacitor C11, a resonant switching operation can be implemented by the diodes D1 and D2.

The rectifying circuit for high-frequency power supply according to the present invention is configured in this way so as to include the three functions (the matching function, the double-voltage rectifying function and the smoothing function) in the single circuit configuration which is not established by using a circuit designing method of keeping those functions separated. The rectifying circuit for high-frequency power supply has a function of performing matching with the output impedance of the resonant type reception antenna 10 and also performing matching with the impedance of the partial resonance circuit configured with the capacitors C1, C2, C3 and C11, and the inductor L11 by using a compound function according to the inductor L11 and the capacitor C11, and also has a function of causing the diodes D1 and D2 to perform the partial resonant switching in the switching operation at the time of rectification by using the partial resonance circuit. As a result, the switching loss of the diodes D1 and D2 is reduced.

Next, the operation of the rectifying circuit for high-frequency power supply configured as above will be explained.

First, when the alternating voltage Vin at a high frequency exceeding 2 MHz is inputted from the resonant type reception antenna 10, matching with the output impedance of the resonant type reception antenna 10 and impedance matching with the partial resonance circuit configured with the capacitors C1, C2, C3 and C11, and the inductor L11 are achieved by the compound function according to the inductor L11 and the capacitor C11. Then, while the matching state is maintained, the inputted alternating voltage Vin is rectified into a ripple voltage having a one-sided electric potential (a positive electric potential) by the diodes D1 and D2. At that time, the switching operation by the diodes D1 and D2 becomes a partial resonant switching operation by virtue of the compound function according to the capacitors C1, C2, C3 and C11, and the inductor L11, and enters a ZVS (zero voltage switching) state. This state corresponds to a rectifying operation having the lowest switching loss. Then, the ripple voltage after being rectified is smoothed into a direct voltage by the capacitor C21, and the direct voltage is outputted.

Through the above-mentioned series of operations, the rectifying circuit for high-frequency power supply can rectify the inputted alternating voltage Vin at a high frequency into a direct voltage with high power conversion efficiency (equal to or greater than 90%), and output the direct voltage.

As mentioned above, because the rectifying circuit for high-frequency power supply according to this Embodiment 1 is configured in such a way as to include the function of performing impedance matching with a circuit at a high frequency characteristic in its output impedance, such as the resonant type reception antenna 10, and the function of operating as a part of the partial resonant operation of the voltage doubler rectifier circuit thereof, the loss at the time of the rectifying operation at a high frequency exceeding 2 MHz can be greatly reduced, and high power conversion efficiency (efficiency of 90% or more) can be achieved.

Further, because the power loss in the circuit which occurs at the time of the rectifying operation is small, and hence the heat energy generated is also small and the temperature rise of the circuit board is suppressed to a low value, the influence of the operating environment temperature exerted on the life of the used parts can be reduced. Therefore, a measure, such as a measure of providing a conventional exhaust heat device, is not needed, and a cost reduction, downsizing, a weight reduction and low power consumption can be achieved.

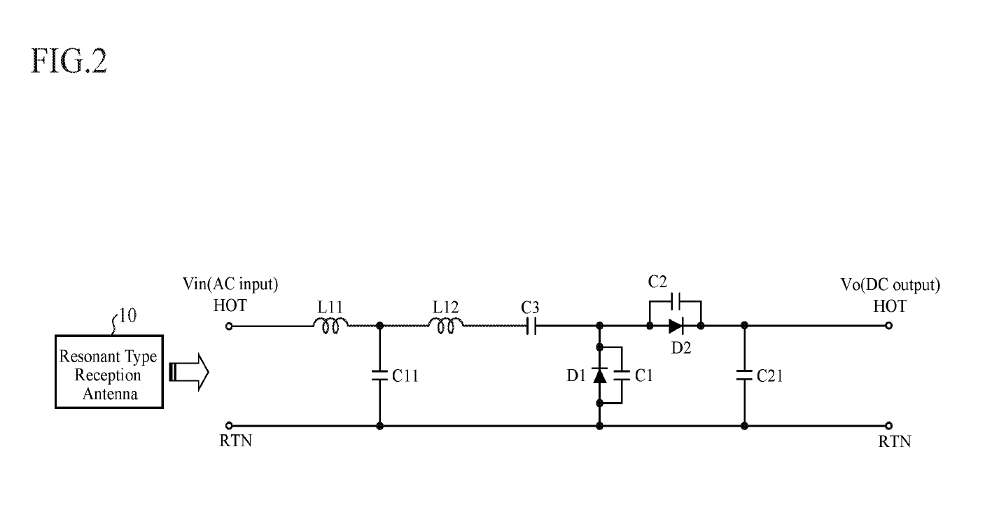

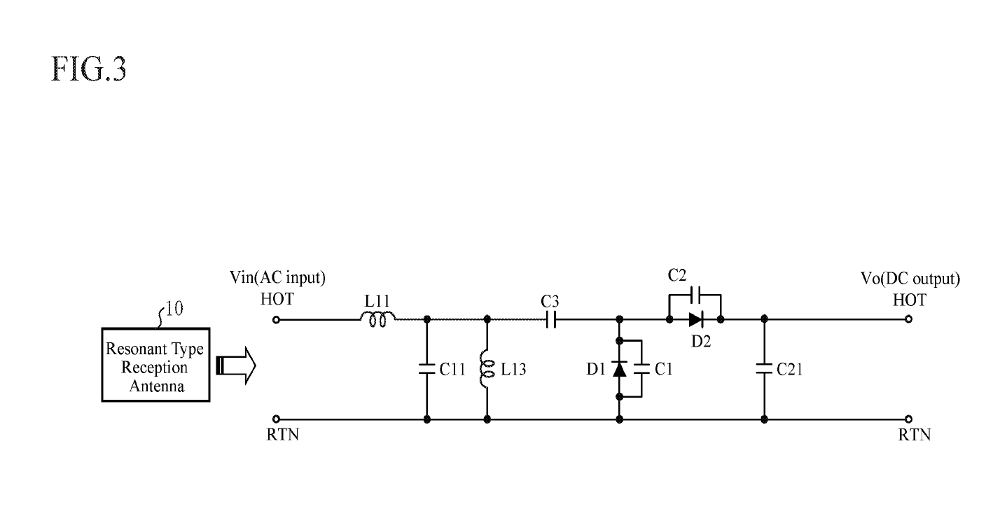

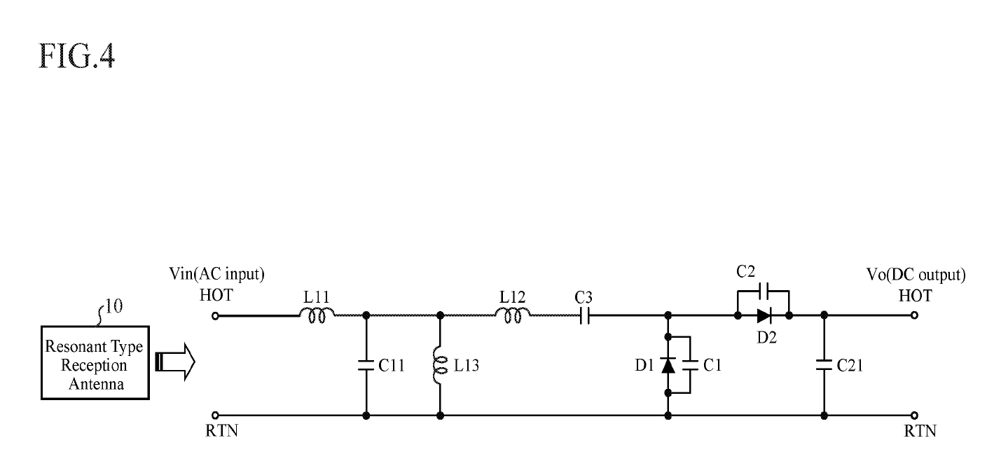

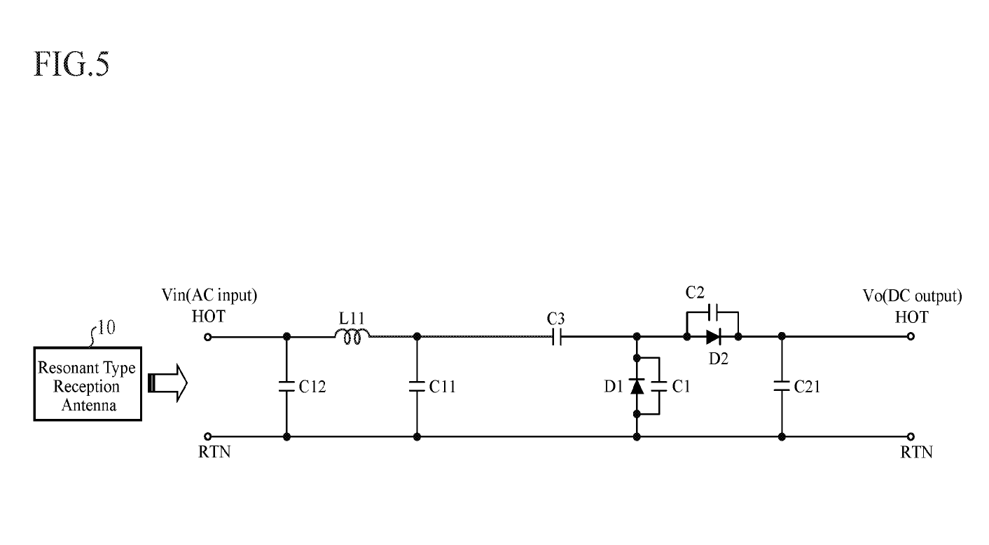

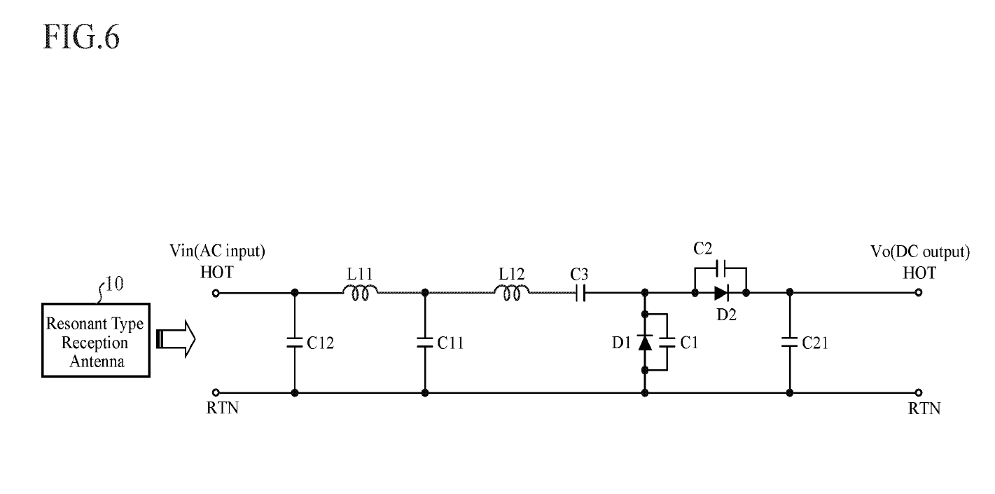

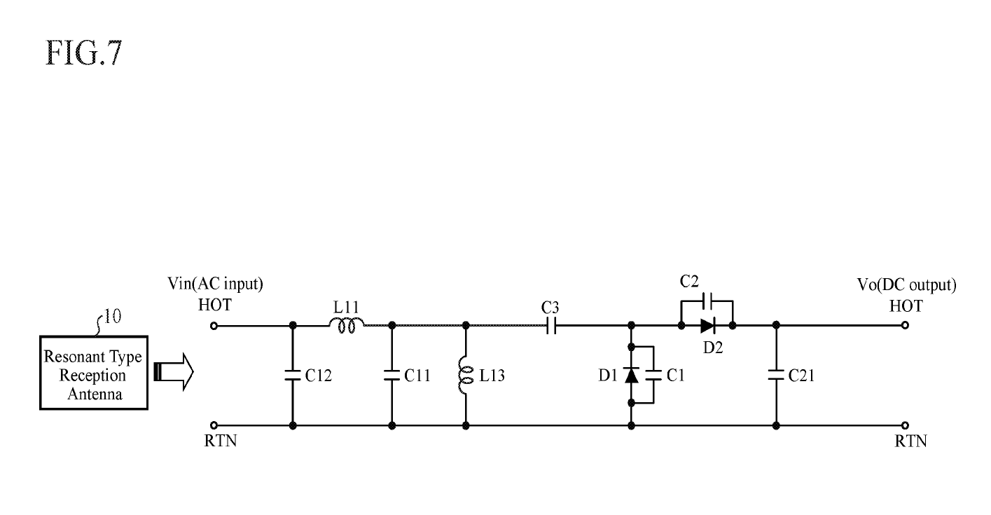

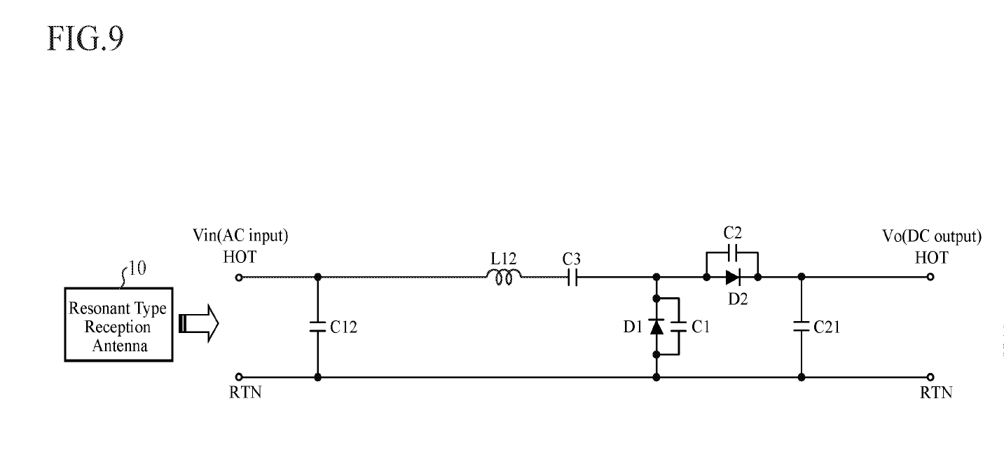

Incidentally, the case in which the rectifying circuit for high-frequency power supply is configured using the diodes D1 and D2, the capacitors C1, C2, C3 and C11, the inductor L11, and the capacitor C21 is shown in FIG. 1. However, this embodiment is not limited to this example. For example, the rectifying circuit for high-frequency power supply can have a configuration as shown in any one of FIGS. 2 to 9. In this case, the rectifying circuit for high-frequency power supply can have a configuration which is an optimal one selected from among the configurations shown in FIGS. 1 to 9 according to both the configuration (the output impedance) of the resonant type reception antenna 10, and the input impedance of a device which is connected to the output (DC output) of the rectifying circuit for high-frequency power supply.

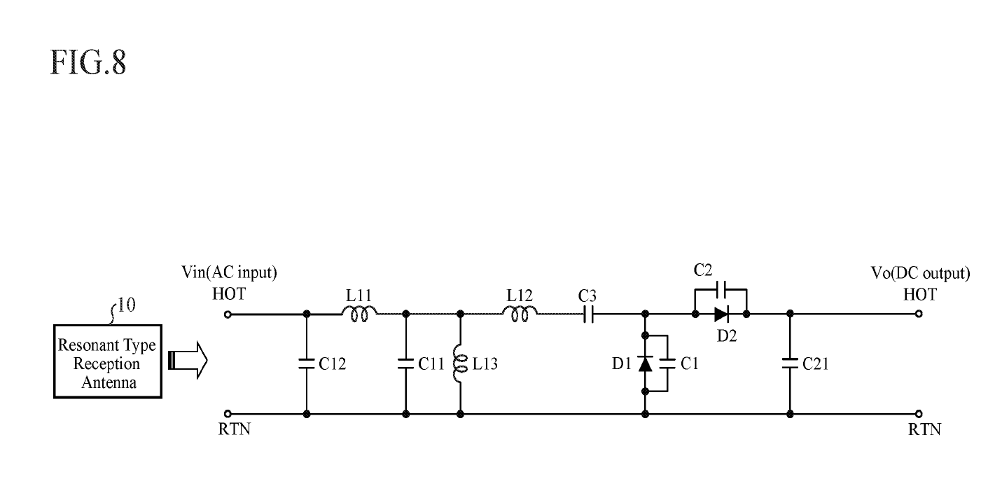

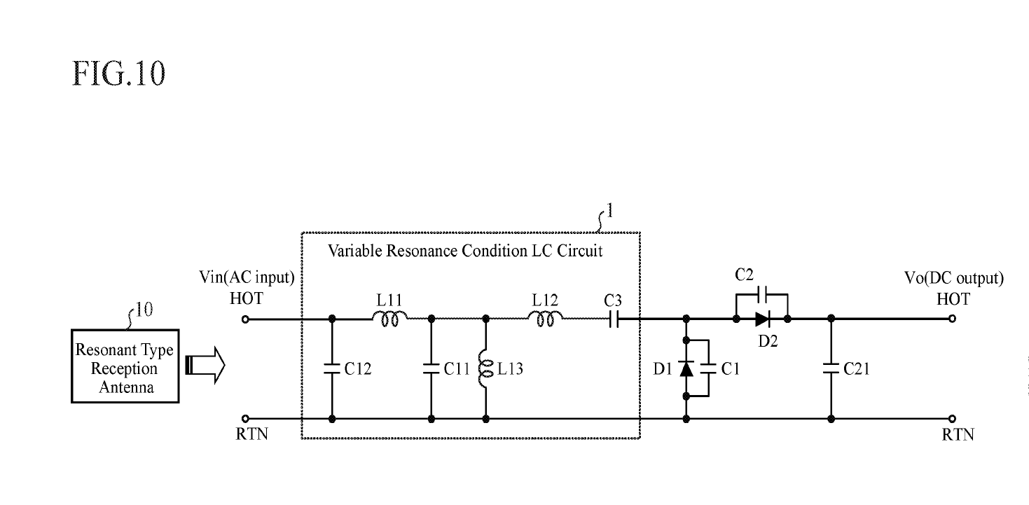

Further, although the explanation is made as to the example shown in FIG. 1 by assuming that the constants of the inductor L11 and the capacitor C12 which construct the matching functional circuit are fixed and the resonance condition is fixed, this embodiment is not limited to this example. A variable resonance condition LC circuit 1 that causes the resonance condition to be variable can be used, as shown in, for example, FIG. 10. FIG. 10 shows an example in which the variable resonance condition LC circuit 1 is applied to the configuration shown in FIG. 8 and having the largest parts count among the configurations shown in FIGS. 1 to 9, and the variable range of the resonance condition is the widest. In the example of FIG. 10, the variable resonance condition LC circuit 1 sets the constants of the inductors L11, L12 and L13 and the capacitors C3, C11 and C12 to be variable.

The variable resonance condition LC circuit 1 can be applied similarly to the examples shown in FIGS. 1 to 7, and 9.

### Embodiment 2

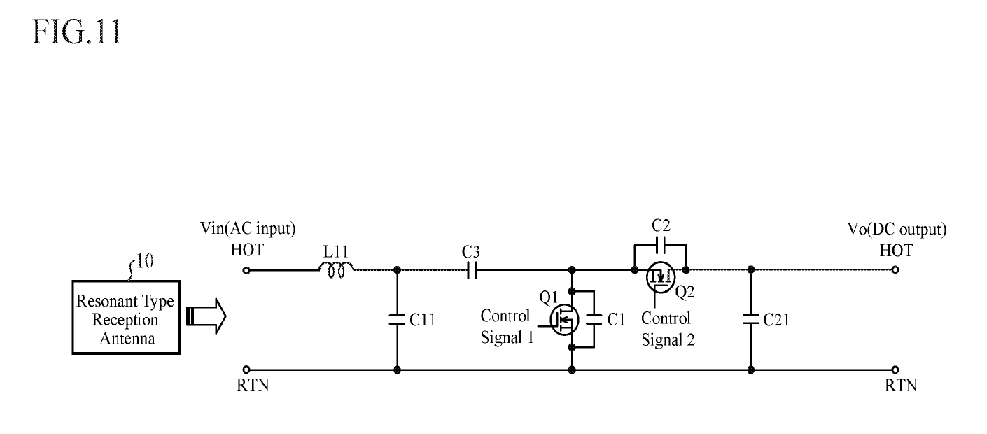

FIG. 11 is a diagram showing the configuration of a rectifying circuit for high-frequency power supply according to Embodiment 2 of the present invention. The rectifying circuit for high-frequency power supply according to Embodiment 2 shown in FIG. 11 is one in which the diodes D1 and D2 of the rectifying circuit for high-frequency power supply according to Embodiment 1 shown in FIG. 1 are replaced by power elements Q1 and Q2. The other components are the same as those according to Embodiment 1 and are designated by the same reference character strings, and an explanation will be made as to only a different portion.

The power elements Q1 and Q2 are a rectifying element that constructs a voltage doubler rectifier circuit for converting an alternating voltage Vin at a high frequency exceeding 2 MHz, which is inputted from a resonant type reception antenna 10, into a direct voltage. As these power elements Q1 and Q2, not only field effect transistors for RF (FETs) but also elements, such as Si-MOSFETs, SiC-MOSFETs or GaN-FETs, can be used. Capacitors C1 and C2 consist of either the parasitic capacitances of the power elements Q1 and Q2 or combined capacitances of the parasitic capacitances and the capacitance of a discrete element.

Even in the case in which the rectifying circuit for high-frequency power supply is configured using the power elements Q1 and Q2 in this way, instead of using the diodes D1 and D2, the same advantages as those provided by Embodiment 1 can be provided.

The configuration in which the diodes D1 and D2 shown in FIG. 1 are replaced by the power elements Q1 and Q2 is shown in FIG. 11. However, this embodiment is not limited to this example. For example, the rectifying circuit for high-frequency power supply can have a configuration in which the diodes D1 and D2 shown in any one of FIGS. 2 to 9 are replaced by the power elements Q1 and Q2. In this case, the rectifying circuit for high-frequency power supply can have a configuration which is an optimal one selected from among configurations in which the diodes D1 and D2 shown in FIGS. 1 to 9 are replaced by the power elements Q1 and Q2, according to both the configuration (the output impedance) of the resonant type reception antenna 10, and the input impedance of a device which is connected to the output (DC output) of the rectifying circuit for high-frequency power supply.

Further, although the explanation is made as to the example shown in FIG. 11 by assuming that the constants of the inductor L11 and the capacitor C11 which construct the matching functional circuit are fixed and that the resonance condition is fixed, this embodiment is not limited to this example. A variable resonance condition LC circuit 1 that causes the resonance condition to be variable can be used. Further, also in the configuration in which the diodes D1 and D2 shown in any one of FIGS. 2 to 9 are replaced by the power elements Q1 and Q2, the variable resonance condition LC circuit 1 can be similarly applied.

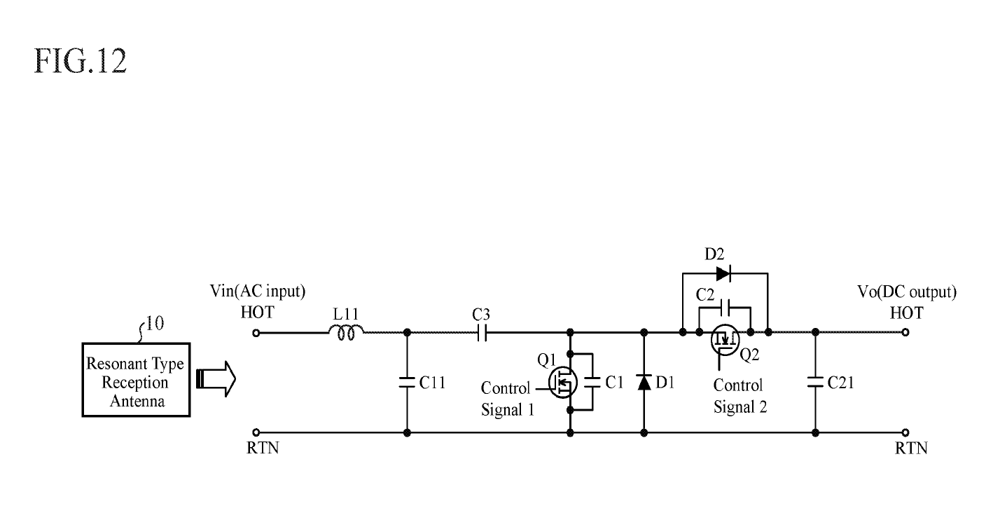

Further, the case in which the diodes D1 and D2 are used as the rectifying element is shown in Embodiment 1 while the case in which the power elements Q1 and Q2 are used as the rectifying element is shown in Embodiment 2. In contrast with this, both the diodes D1 and D2 and the power elements Q1 and Q2 can be used as the rectifying element, as shown in FIG. 12. Although FIG. 12 shows the case in which the rectifying element shown in FIG. 1 is replaced by the rectifying element in which the diodes D1 and D2 and the power elements Q1 and Q2 are used, this embodiment is not limited to this example. For example, the rectifying element shown in any one of FIGS. 2 to 9 can be replaced by the rectifying element in which the diodes D1 and D2 and the power elements Q1 and Q2 are used. In addition, the variable resonance condition LC circuit 1 can be applied to any one of these configurations.

In addition, while the invention has been described in its preferred embodiments, it is to be understood that an arbitrary combination of two or more of the embodiments can be made, various changes can be made in an arbitrary component according to any one of the embodiments, and an arbitrary component according to any one of the embodiments can be omitted within the scope of the invention.

### INDUSTRIAL APPLICABILITY

The rectifying circuit for high-frequency power supply according to the present invention can provide a high power conversion efficiency characteristic in the rectification of an alternating voltage at a high frequency exceeding 2 MHz, and is suitable for use as a rectifying circuit for high-frequency power supply or the like that rectifies an alternating current power supply at a high frequency.

### EXPLANATIONS OF REFERENCE NUMERALS

1 variable resonance condition LC circuit, and 10 resonant type reception antenna (reception antenna for power transmission).

1. A rectifying circuit for high-frequency power supply that rectifies an alternating voltage at a high frequency exceeding 2 MHz, said rectifying circuit for high-frequency power supply comprising:
a voltage doubler rectifier circuit that rectifies said alternating voltage inputted from a reception antenna for power transmission;
a partial resonance circuit that causes said voltage doubler rectifier circuit to perform partial resonant switching in a switching operation at a time of rectification;
a matching functional circuit that has a function of matching a resonance condition to that of said reception antenna for power transmission, and a function of matching the resonance condition to that of said partial resonance circuit; and
a smoothing functional circuit that smooths the voltage rectified by said voltage doubler rectifier circuit into a direct voltage.

2. The rectifying circuit for high-frequency power supply according to claim 1, wherein said voltage doubler rectifier circuit is configured using diodes.

3. The rectifying circuit for high-frequency power supply according to claim 2, wherein said diodes are ones other than diodes for high frequency.

4. The rectifying circuit for high-frequency power supply according to claim 1, wherein said voltage doubler rectifier circuit is configured using field effect transistors.

5. The rectifying circuit for high-frequency power supply according to claim 1, wherein said voltage doubler rectifier circuit is configured using diodes and field effect transistors.

6. The rectifying circuit for high-frequency power supply according to claim 1, wherein said matching functional circuit matches the resonance condition to that of said reception antenna for power transmission according to magnetic-field resonance.

7. The rectifying circuit for high-frequency power supply according to claim 1, wherein said matching functional circuit matches the resonance condition to that of said reception antenna for power transmission according to electric-field resonance.

8. The rectifying circuit for high-frequency power supply according to claim 1, wherein said matching functional circuit matches the resonance condition to that of said reception antenna for power transmission according to electromagnetic induction.

9. The rectifying circuit for high-frequency power supply according to claim 1, wherein said matching functional circuit causes the resonance condition to be variable.
